(19) United States
(12) Patent Application Publication
(10) Pub. No.: US 2026/0114621 A1
(43) Pub. Date: Apr. 30, 2026

(54) PEGBOARD MONITOR MOUNT

(71) Applicant: CKnapp Sales, Inc., Goodfield, IL (US)

(72) Inventors: Nicholas Welander, East Peoria, IL (US); Ohm Vyas, Geneva, IL (US); Micah Fehr, Danvers, IL (US)

(21) Appl. No.: 19/033,445

(22) Filed: Jan. 21, 2025

Related U.S. Application Data
(60) Provisional application No. 63/711,817, filed on Oct. 25, 2024.

(51) Int. Cl. A47B 97/00; F16M 11/12; F16M 13/02

(52) U.S. Cl. CPC A47B 97/001; F16M 11/126; F16M 13/022; F16M 2200/066

(57) ABSTRACT

A monitor mount configured for attachment to a pegboard includes a pegboard mounting plate, the pegboard mounting plate including, a base configured to register with a frontside of the pegboard, a pegboard hook attached to the base, the pegboard hook including a set of prongs configured to pass through pegboard holes and register with a backside of the pegboard, and a bottom support attached to the base, the bottom support configured to resist tilting of the pegboard mounting plate relative to the pegboard. The monitor mount also includes a monitor mounting plate attached to the base.

### RELATED APPLICATION

This application claims the benefit of and priority to U.S. Provisional Application No. 63/711,817, filed Oct. 25, 2024, which is incorporated by reference herein.

### TECHNICAL FIELD

This disclosure relates to monitor mounts.

### BRIEF SUMMARY

Monitor mounts disclosed herein facilitate mounting monitors or other displays to a pegboard. The disclosed examples include a pegboard mounting plate configured for attachment to a pegboard and a monitor mount attached thereto. The pegboard mounting plate includes elements for secure attachment to pegboard to support the weight and any dynamic loading of a monitor mounted to the monitor mount. In disclosed examples, the pegboard mounting plate includes a pegboard hook with a set of prongs configured to pass through pegboard holes and register with a backside of a pegboard. The pegboard mounting plate further includes a bottom support that resists tilting of the pegboard mounting plate relative to the pegboard to keep the set of prongs engaged with the pegboard. In some examples, the bottom support may include a magnet and/or a second set of prongs. Examples including a magnet may be particularly suitable for attaching the monitor mount to a ferromagnetic pegboard, such as a steel pegboard.

In one example, a monitor mount configured for attachment to a pegboard includes a pegboard mounting plate, the pegboard mounting plate including, a base configured to register with a frontside of the pegboard, a pegboard hook attached to the base, the pegboard hook including a set of prongs configured to pass through pegboard holes and register with a backside of the pegboard, and a bottom support attached to the base, the bottom support configured to resist tilting of the pegboard mounting plate relative to the pegboard. The monitor mount also includes a monitor mounting plate attached to the base.

In another example, an assembly includes a pegboard including a sheet material with an array of pegboard holes, and a monitor mount. The monitor mount includes a pegboard mounting plate, the pegboard mounting plate including, a base configured registered with a frontside of the pegboard, a pegboard hook attached to the base, the pegboard hook including a set of prongs passing through pegboard holes in the array of pegboard holes and registering with a backside of the pegboard, and a bottom support attached to the base, the bottom support configured to resist tilting of the pegboard mounting plate relative to the pegboard. The monitor mount also includes a monitor mounting plate attached to the base.

### BRIEF DESCRIPTION OF THE DRAWINGS

FIG. 1 illustrates a monitor mount configured for attachment to a pegboard.

FIGS. 2A-2C illustrate steps for mounting a monitor to a pegboard with the monitor mount of FIG. 1.

FIG. 3 illustrates a modified version of the monitor mount of FIG. 1.

FIG. 4 illustrates another example of a monitor mount configured for attachment to a pegboard.

FIGS. 5A-5B illustrate steps for mounting a monitor to a pegboard with the monitor mount of FIG. 4.

### DETAILED DESCRIPTION

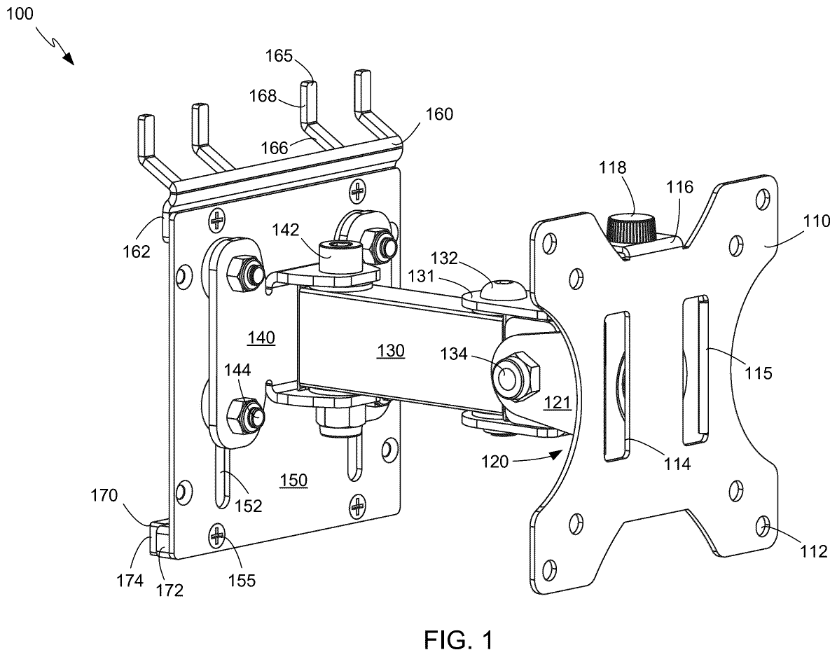

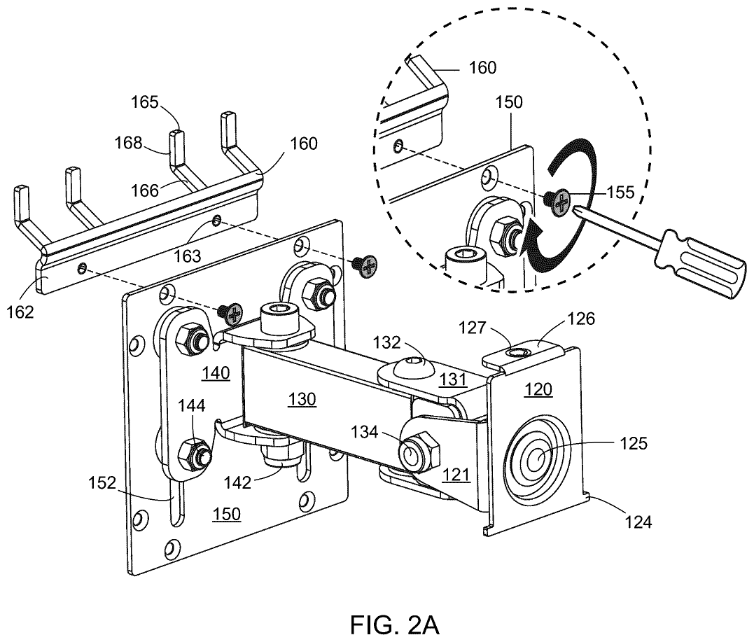

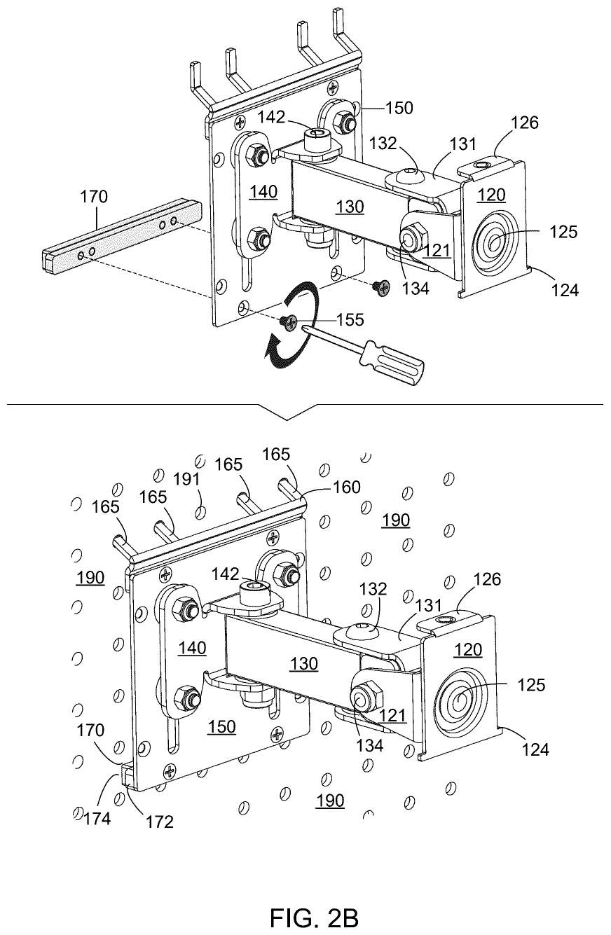

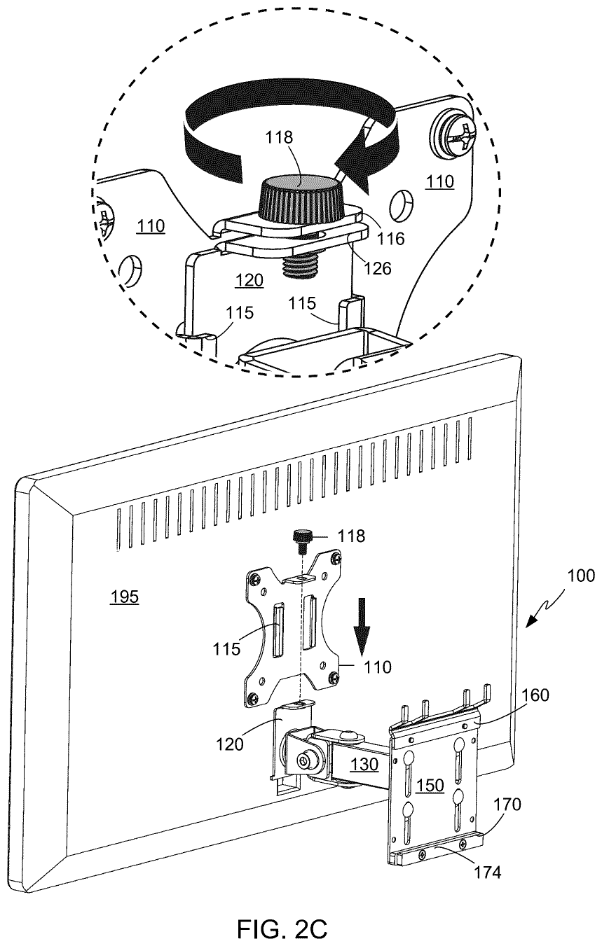

FIG. 1 illustrates a monitor mount 100 configured for attachment to a pegboard, such as pegboard 190 (FIG. 2B). FIGS. 2A-2C illustrate steps for mounting a monitor 195 to pegboard 190 with the monitor mount 100. The monitor mount 100 includes a base 150 configured to register with a frontside of the pegboard 190 and a monitor mounting plate 110 attached to the base 150.

A pegboard hook 160 extends from the base 150, the pegboard hook 160 including a set of prongs 165 configured to pass through pegboard holes 191 and register with a backside of the pegboard 190. The pegboard 190 may be a standard pegboard formed from a planar sheet material with an array of pegboard holes in a grid pattern, the set of prongs 165 being spaced to correspond to a plurality of pegboard holes 191 of the array of pegboard holes.

The pegboard hook 160 includes a metal plate 162 with threaded holes 163 to receive screws 155 for mounting to the base 150. A bottom support is also connected to the base 150, the bottom support configured to resist tilting of the pegboard mounting plate relative to the pegboard 190 to keep the set of upward facing prongs 165 engaged with the pegboard 190.

In the example of monitor mount 100, the bottom support is a magnet support 170. The magnet support 170 includes a metal plate 172 with threaded holes to receive screws 155, and a magnet 174. The magnet 174 is attached to the metal plate 172 opposite the screws and is configured to register with a frontside of the pegboard 190. Magnet support 170 is suitable for pegboards formed from a ferromagnetic sheet material such that the magnet 174 magnetically attaches to the sheet material of the pegboard 190.

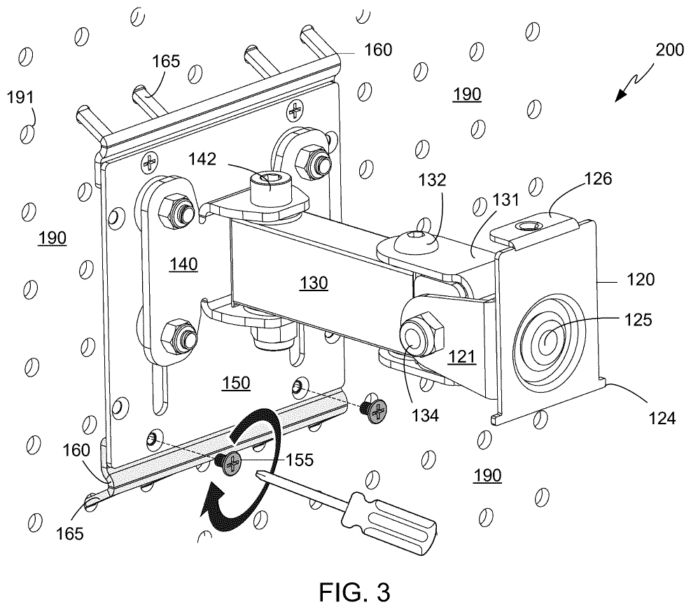

FIG. 3 illustrates a monitor mount 200. The monitor mount 200 is a modified version of the monitor mount 100 in that the magnetic bottom support 170 has been replaced with a second pegboard hook 160. The monitor mount 200 is otherwise the same as the monitor mount 100. In monitor mount 200, the bottom support includes the second pegboard hook 160 attached to the base 150, the second pegboard hook 160 including a second set of prongs 165 configured to pass through pegboard holes 191 and register with the backside of the pegboard 190. The first set of prongs 165 is an upward facing set of prongs 165, whereas the prongs of the bottom support are oriented in the opposite direction as a downward facing set of prongs 165. In other examples, the first set of prongs and the second set of prongs may both be upward facing, but such a configuration allows the base 150 to be removed from the pegboard 190 by lifting the monitor mount 200.

In the example of the downward facing prongs 165 as shown in the monitor mount 200, attaching base 150 to the pegboard 190 requires mating the subassembly including the base 150 and the upper pegboard hook 160 to the pegboard 190 and mating the lower pegboard hook 160 to the pegboard 190. Then, screws 155 are used to attach the lower pegboard hook 160 to the base 150. In this manner, the second set of prongs 165 is releasably attached to the base 150. Once attached to the pegboard 190, the opposing directions of the upper and lower pegboard hooks 160 prevent the pegboard hooks 160 from coming out of the pegboard holes 191 such that the monitor mount 200 is securely fastened to the pegboard 190.

Additional details described with respect to monitor mount 100 are equally applicable to monitor mount 200. For both monitor mount 100 and monitor mount 200, the prongs 165 in each pegboard hook 160 are located along a line spaced at regular intervals corresponding to spacing of the pegboard holes 191 in the pegboard 190. For example, with a standard pegboard, the spacing of the pegboard holes 191 is in a one inch grid pattern. While any number of prongs may be used including two or even one prong, at least three prongs 165 along the line provides better stability than fewer prongs. The example of pegboard hook 160 includes four prongs, spread over 5 inches, leaving a two inch center gap between the inner two prongs of the set of prongs 165.

As shown in FIG. 1, each of the set of prongs 165 includes a transverse portion 166 configured to extend though a pegboard 190 hole of the pegboard holes 191 and a lateral portion 168 configured to register with the backside of the pegboard 190.

Monitor mount 100 includes a monitor mounting plate 110 attached to the base 150. The monitor mounting plate 110 includes mounting holes 112 to facilitate attachment to a monitor. In some examples, the mounting holes 112 may conform to a VESA standard display mount. Such VESA standard display mounts include rectangular hole patterns such as 50×20 mm, 75×35 mm, 75×75 mm, 100×100 mm, 200×100 mm, 400×200 mm, 600×400 mm, and others in 200 mm increments.

In the example of monitor mount 100, the monitor mounting plate 110 is releasably attached to the base 150. This facilitates attaching the monitor mounting plate 110 to a monitor 195 and then attaching the monitor mounting plate 110 and the monitor 195 to the base 150.

In the example of monitor mount 100, the monitor mount 100 includes a monitor mount bracket 120 secured to the base 150, and the monitor mounting plate 110 is releasably attached to the monitor mount bracket 120.

As illustrated in FIGS. 2B and 2C, the monitor mounting plate 110 and the monitor mount bracket 120 include mating elements. In particular, the monitor mount bracket 120 includes a planar frontal surface with an upper transverse tab 126 and planar bottom protrusions 124. The monitor mounting plate 110 includes a planar rear surface vertical slots 114 and vertical tracks 115 spaced to receive the vertical edges of monitor mount bracket 120. When in position, the planar bottom protrusions 124 catch on the bottom side of the vertical tracks 115. The monitor mounting plate 110 further includes an upper transverse tab 116 that registers with the upper transverse tab 126 of the monitor mount bracket 120. The upper transverse tab 116 includes a through hole to receive a thumb screw 118 whereas the upper transverse tab 126 includes a threaded through hole 127 to engage the thumb screw 118.

As shown in FIG. 2C, to form an assembly including monitor mount 100, pegboard 190 and monitor 195, the monitor mounting plate 110 is first attached to the monitor 195 with screws through holes 112. Then the monitor mounting plate 110 is attached to the monitor mount bracket 120 by sliding vertical tracks 115 over the planar frontal surface of the monitor mount bracket 120. The monitor mounting plate 110 secured by inserting thumb screw 118 into through the hole in the upper transverse tab 116 of the monitor mounting plate 110 and turning the thumb screw to engage the threaded hole 127 in the upper transverse tab 126 of the monitor mount bracket 120.

Monitor mount 100 includes a number of elements to facilitate positioning adjustments of the monitor 195 mounted to the monitor mounting plate 110 with the base 150 attached to pegboard 190. Each positioning adjustment changes the orientation of the monitor mount 100 relative to the base. Starting at the base 150 and moving outward to the monitor mounting plate 110, the first positioning adjustment element provides for height adjustment. The height adjustment comes from loosening nuts and bolts 144 holding bracket 140 to base 150. The nuts and bolts 144 are engaged in vertical slots 152 such that the height of the bracket 140 is adjustable relative to base 150.

Monitor mount 100 also includes an arm 130 coupling the monitor mount 100 to the base 150. The next positioning adjustment element is an arm angle adjustment pivot 142 between the base 150 and the arm 130. In particular, the arm angle adjustment pivot 142 includes a screw and nut engaged with holes in bracket 140. The arm angle adjustment pivot 142 allows the arm 130 to swing horizontally approximately 180 degrees.

The next positioning adjustment element is a viewing angle adjustment pivot 132 between the arm 130 and the arm mount bracket 131. In particular, the viewing angle adjustment pivot 132 includes a screw and nut engaged with holes in the arm 130. The viewing angle adjustment pivot 132 allows the monitor mounting plate 110 to swing horizontally approximately 180 degrees relative to the distal end of the arm 130.

The next positioning adjustment element is a tilt adjustment pivot 134 between the arm mount bracket 131 and the monitor mount bracket 121. In particular, the viewing angle adjustment pivot 132 includes a screw and nut engaged with holes in the arm mount bracket 131. The tilt adjustment pivot 134 allows the monitor mounting plate 110 to swing vertically to set the tilt of the monitor 195.

Moreover, the monitor mounting plate 110 is connected to the monitor mount bracket 121 with a rotational pivot 125. The rotational pivot may allow the monitor mounting plate 110 to spin a full 360 degrees relative to the monitor mount bracket 121. This allows a user to orient the monitor 195 at any angle, such as a landscape or portrait orientation.

The components of monitor mount 100 are configured to support efficient production and manufacturing. For example, a variety of the components may be formed from stamped sheet metal, the stamping both bending the metal and forming holes and other features in the components. Of course, other materials and manufacturing techniques may also be used.

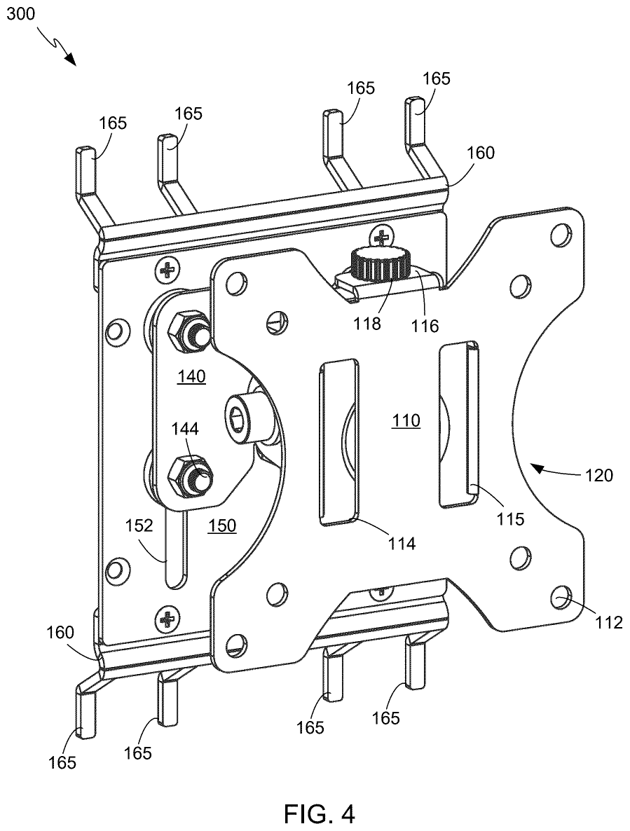

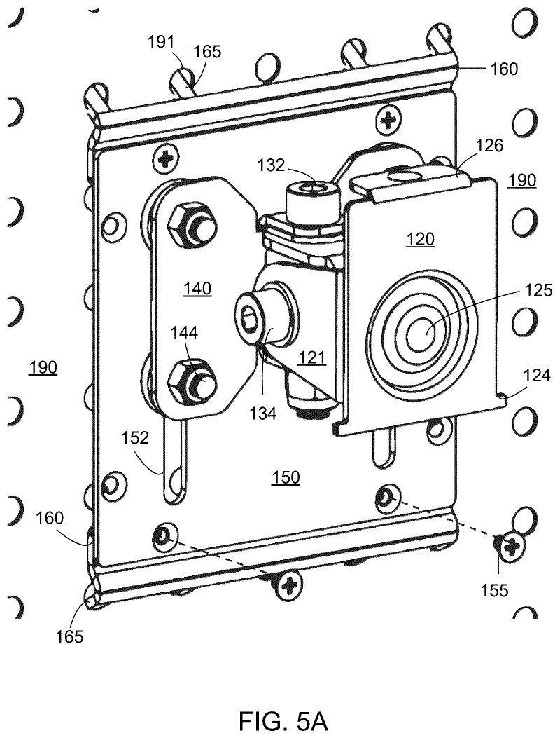

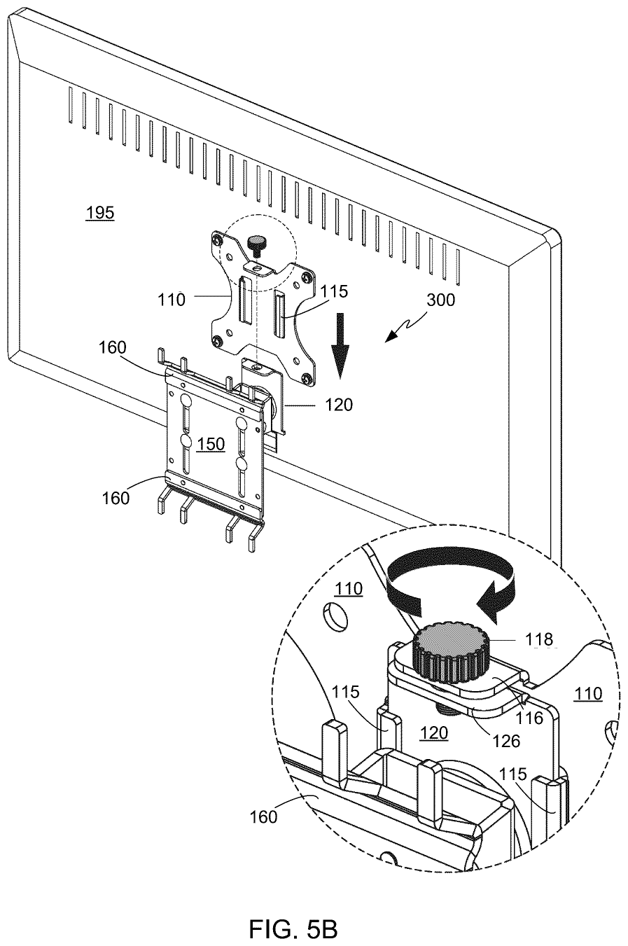

FIG. 4 illustrates another example of a monitor mount 300 configured for attachment to a pegboard. FIGS. 5A-5B illustrate steps for mounting a monitor to a pegboard with the monitor mount 300.

Monitor mount 300 is substantially similar to monitor mount 200 except that it does not include the arm 130. Instead, the viewing angle adjustment pivot 132 includes a screw and nut engaged with holes in bracket 140. The viewing angle adjustment pivot 132 allows the monitor mounting plate 110 to swing horizontally relative to the bracket 140. However, without the arm 130, the adjustment will be limited due to the close proximity of the monitor 195 to the pegboard 190.

In all other aspects, the monitor mount 300 is substantially similar to monitor mount 200. All other details of the monitor mount 200 should be attributed to the monitor mount 300. For brevity, these details are not repeated with respect to monitor mount 300.

Any reference to specific directions or orientations is for illustrative purposes and does not restrict the flexibility or adaptability of this disclosure. In particular, all references to spatial orientation—such as, but not limited to, vertical, horizontal, front, rear, above, below, upward, and downward—are merely intended to describe the relative positioning of elements. These terms should be interpreted as contextual descriptors based on the perspective of the described examples, and are not to be construed as imposing any absolute orientation. The absolute positioning of elements may shift in different examples and implementations.

The specific techniques for pegboard monitor mounts, including techniques described with respect to monitor mounts 100, 200, 300 are merely illustrative of the general inventive concepts included in this disclosure as defined by the following claims.

What is claimed is:

1. A monitor mount configured for attachment to a pegboard, the monitor mount comprising:
a pegboard mounting plate, the pegboard mounting plate including:
a base configured to register with a frontside of the pegboard;
a pegboard hook attached to the base, the pegboard hook including a set of prongs configured to pass through pegboard holes and register with a backside of the pegboard; and
a bottom support attached to the base, the bottom support configured to resist tilting of the pegboard mounting plate relative to the pegboard; and
a monitor mounting plate attached to the base.

2. The monitor mount of claim 1, wherein the bottom support includes a magnet configured to register with a frontside of the pegboard.

3. The monitor mount of claim 1,
wherein the pegboard hook is a first pegboard hook with a first set of prongs,
wherein the bottom support includes a second pegboard hook attached to the base, the second pegboard hook including a second set of prongs configured to pass through the pegboard holes and register with the backside of the pegboard.

4. The monitor mount of claim 3,
wherein the first set of prongs is an upward facing set of prongs, and
wherein the second set of prongs is a downward facing set of prongs.

5. The monitor mount of claim 4, wherein the second set of prongs is releasably attached to the base.

6. The monitor mount of claim 1, wherein each prong in the set of prongs is located along a line spaced at regular intervals corresponding to spacing of the pegboard holes in the pegboard.

7. The monitor mount of claim 6, wherein the spacing of the pegboard holes is one inch.

8. The monitor mount of claim 6, wherein the set of prongs includes at least three prongs along the line.

9. The monitor mount of claim 1, wherein each of the set of prongs includes a transverse portion configured to extend though a pegboard hole of the pegboard holes and a lateral portion configured to register with the backside of the pegboard.

10. The monitor mount of claim 1, further comprising a tilt adjustment pivot between the base and the monitor mount.

11. The monitor mount of claim 10, further comprising a view angle adjustment pivot between the base and the monitor mount.

12. The monitor mount of claim 1, further comprising:
an arm coupling the monitor mount to the base,
an arm angle adjustment pivot between the base and the arm; and
a view angle adjustment pivot between the arm and the monitor mount.

13. The monitor mount of claim 12, further comprising a tilt adjustment pivot between the arm and the monitor mount.

14. The monitor mount of claim 1, wherein the monitor mount is releasably attached to the base.

15. The monitor mount of claim 14, further comprising a monitor mount bracket secured to the base,
wherein the monitor mounting plate is releasably attached to the monitor mount bracket.

16. The monitor mount of claim 1, wherein the monitor mounting plate includes mounting holes that conform to a VESA standard mount.

17. An assembly comprising:
a pegboard including a sheet material with an array of pegboard holes; and
a monitor mount comprising:
a pegboard mounting plate, the pegboard mounting plate including:
a base configured registered with a frontside of the pegboard;
a pegboard hook attached to the base, the pegboard hook including a set of prongs passing through pegboard holes in the array of pegboard holes and registering with a backside of the pegboard; and
a bottom support attached to the base, the bottom support configured to resist tilting of the pegboard mounting plate relative to the pegboard; and
a monitor mounting plate attached to the base.

18. The assembly of claim 17,
wherein the sheet material is a ferromagnetic sheet material, and
wherein the bottom support includes a magnet magnetically attached to the sheet material.

19. The assembly of claim 17,
wherein the pegboard hook is a first pegboard hook with a first set of prongs,
wherein the bottom support includes a second pegboard hook attached to the base, the second pegboard hook including a second set of prongs passing through pegboard holes in the array of pegboard holes and registering with the backside of the pegboard.

20. The assembly of claim 17, further comprising a monitor mounted to the monitor mounting plate.
